(19) United States
(12) Patent Application Publication
(10) Pub. No.: US 2003/0084460 A1
(43) Pub. Date: May 1, 2003

(54) Method and apparatus reproducing contents from information storage medium in interactive mode

(75) Inventors: Hyun-Kwon Chung, Gyeonggi-do (KR); Jung-wan Ko, Gyeonggi-do (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon-City (KR)

(21) Appl. No.: 10/277,094

(22) Filed: Oct. 22, 2002

(30) Foreign Application Priority Data
Oct. 23, 2001 (KR) 2001-65391
Jan. 12, 2002 (KR) 2002-1887
May 17, 2002 (KR) 2002-27341
Sep. 24, 2002 (KR) 2002-57813

(51) Int. Cl. H04N 7/16

(52) U.S. Cl. 725/142

(57) ABSTRACT

A method and apparatus reproducing content of an information storage medium interactively by receiving information, which is necessary for reproducing the content in the interactive mode, from Internet or from the information storage medium, and reproducing the content interactively based on the received or read information, thereby allowing dynamic and/or automatic update of an interactive screen content. Further, even if the necessary information for reproducing the content interactively is not recorded on the information storage medium, the content can be reproduced interactively.

### CROSS-REFERENCE TO RELATED APPLICATIONS

This application is based upon and claims priority from Korean Patent Application Nos. 2001-65391 filed Oct. 23, 2001, 2002-1887 filed Jan. 12, 2002, 2002-27341 filed May 17, 2002, and 2002-57813 filed Sep. 24, 2002 in the Korean Intellectual Property Office, the contents of all of which are incorporated herein by reference.

### BACKGROUND OF THE INVENTION

1. Field of the Invention

The present invention relates to a method and apparatus reproducing contents, which are recorded on an image storage medium, in an interactive mode (i.e., interactively with a presentation or interactively by reproducing annotations or content related information together with reproduction of the content automatically and/or upon user request).

2. Description of the Related Art

There have been proposed interactive digital versatile discs (DVDs) from which contents can be reproduced (played) in an interactive mode based on documents that have tagged elements according to a standard of organizing and tagging elements of a document, such as a markup language document, and software interpreting the documents to control a personal computer (PC), such as formatting and displaying information, including displaying interactive presentation information requiring user input and displaying multimedia data, communicating data, organizing data, playing audio, etc. In particular, interactive DVDs are DVDs on which a markup document is recorded together with audio/video (AV) data. The AV data can be reproduced from interactive DVDs in two kinds of modes: a video mode in which the AV data is displayed in the same manner as AV data is reproduced from normal DVDs, and an interactive mode in which reproduced AV data is displayed on a display window defined by a markup document along with interactive contents. A display screen displayed in the interactive mode is referred to as an interactive screen.

In particular, when a user selects an interactive mode, a browser software interprets and displays a markup document recorded on the interactive DVD. AV data selected by the user and corresponding interactive contents are displayed on a display window defined by the markup document. For example, when the AV data is a movie, a moving picture is displayed on an HTML display window in the markup document, and additional interactive information, such as a script, a synopsis, or pictures of actors and actresses, about the movie may be displayed on the remaining area of the markup document. Further, the additional interactive information may be displayed in synchronization with a title (i.e., AV data). For example, when a particular actor or actress appears, a markup document containing his/her background information can be called and displayed. An example markup document is a HyperText Markup Language (HTML) document.

However, if information supporting an interactive function is not recorded on a conventional DVD-video, AV data recorded on the DVD-video cannot be reproduced in an interactive mode. In other words, contents that are recorded on an information storage medium cannot be reproduced in an interactive mode if information supporting the interactive function is not recorded on the medium. Moreover, even if a disc supports the interactive mode, contents displayed on an interactive screen cannot be updated.

### SUMMARY OF THE INVENTION

To solve at least the above-described problems, a first object of the present invention is to provide a method and apparatus reproducing contents in an interactive mode from an information storage medium when information necessary for reproducing the contents in the interactive mode is not recorded on the information storage medium.

It is a second object of the present invention to provide a method and apparatus reproducing contents in an interactive mode from a disc not supporting an interactive function.

It is a third object of the present invention to provide a method and apparatus updating contents displayed on a markup document screen during interactive reproduction of the contents.

It is a fourth object of the present invention to provide a method and apparatus reading text data information linked to a markup document during interactive reproduction.

Additional objects and advantages of the invention will be set forth in part in the description which follows and, in part, will be obvious from the description, or may be learned by practice of the invention.

To achieve the above and other objects of the present invention, according to an embodiment of the invention, there is provided a method of reproducing a content from an information storage medium in an interactive mode. The method comprises receiving information, which is necessary for reproducing the content in the interactive mode, from the Internet or reading the information from the information storage medium; and reproducing the content in the interactive mode based on the received or read information.

According to an aspect of the invention, receiving the necessary information comprises determining whether the necessary information has been recorded on the information storage medium; and requesting the necessary information from a predetermined server apparatus if the necessary information has not been recorded on the information storage medium.

According to an aspect of the invention, requesting the necessary information comprises transmitting an identifier of the content to the server apparatus; and receiving as the necessary information at least one of a reproducing control file and a markup document which correspond to the identifier from the server apparatus.

According to another embodiment of the invention, there is provided a method of reproducing a video title from a disc in an interactive mode, comprising receiving information, which is necessary for reproducing the video title in the interactive mode, from Internet; and reproducing the video title in the interactive mode based on the received information.

According to an aspect of the invention, receiving the necessary information comprises requesting a reproducing control file and a markup document, which are necessary for reproducing the video title in the interactive mode. According to an aspect of the invention, requesting the necessary information comprises transmitting an identifier of the video title to a server apparatus on the Internet; and receiving the reproducing control file and the markup document which correspond to the identifier.

According to an aspect of the invention, receiving the reproducing control file comprises receiving the markup document containing a client execution code recognizing the identifier of the video title, from the server apparatus. According to an aspect of the invention, receiving the reproducing control file comprises receiving the markup document, reading a position of the reproducing control file linked to the received markup document and receiving the reproducing control file.

According to an aspect of the invention, the received markup document contains either a link tag that is linked to the reproducing control file or an execution code that contains application program interface (API) calls to download the reproducing control file. According to an aspect of the invention, the link tag may be used to retrieve text data. According to an aspect of the invention, the reproducing control file contains designation information designating that the reproducing control file is made for the purpose of controlling reproduction.

According to another embodiment of the invention, there is provided an apparatus reproducing a content from an information storage medium in an interactive mode. The apparatus comprises a reader reading the content from the information storage medium; a decoder decoding the read content; and a network data transceiver transmitting and receiving information, which is necessary for reproducing the content in the interactive mode, to and from Internet. Accordingly, the apparatus reproduces the content in the interactive mode using the necessary information which is read from the information storage medium or received through the network data transceiver.

According to an aspect of the invention, the information necessary for reproducing in the interactive mode comprises a reproducing control file controlling reproduction of the content and display of a markup document together with the reproduced content. The apparatus further comprises a presentation engine that analyzes the reproducing control file and the markup document to perform or reproduce them; and a blender that blends the decoded read content and the reproduced markup document, thereby reproducing the content and displaying the markup document together with the reproduced content.

According to an aspect of the invention, the network data transceiver transmits an identifier of the content to a server apparatus on the Internet and receives the necessary information (i.e., interactive content) corresponding to the identifier from the server apparatus.

According to another embodiment of the invention, there is provided an apparatus reproducing a video title from a disc in an interactive mode. The apparatus comprises a network data transceiver that requests and receives information, which is necessary for reproducing the video title in the interactive mode, from Internet, wherein the video title is reproduced in the interactive mode based on the received information.

According to an aspect of the invention, the network data transceiver requests and receives a reproducing control file and a markup document, which are necessary for reproducing the video title in the interactive mode, from the server apparatus.

### BRIEF DESCRIPTION OF THE DRAWINGS

The above and other objects and advantages of the present invention will become more apparent by describing in detail preferred embodiments thereof with reference to the attached drawings in which:

FIG. 1 is a schematic diagram of a reproducing system according to an embodiment of the present invention;

FIG. 2 is a block diagram of a reproducing apparatus used in the reproducing system shown in FIG. 1, according to an embodiment of the present invention;

FIG. 3 is a schematic diagram of a remote controller used in the reproducing system shown in FIG. 1, according to an embodiment of the present invention;

FIG. 4 is a diagram of a directory structure of a disc which supports an interactive mode, according to an embodiment of the present invention;

FIG. 5 is a display screen diagram of reproducing contents from a disc which supports an interactive mode, according to an embodiment of the present invention;

FIG. 6 is a diagram of a directory structure of a disc which does not support an interactive mode;

FIG. 7 is a display screen diagram of reproducing contents in an interactive mode from the disc shown in FIG. 6, which does not support the interactive mode, according to an embodiment of the present invention;

FIG. 8 is a display screen diagram of updating a content in an interactive mode reproducing screen, according to an embodiment of the present invention;

FIG. 9 is a flowchart of a reproducing method using the reproducing system shown in FIG. 1, according to an embodiment of the present invention; and

FIG. 10 is a flowchart of a reproducing method using the reproducing system shown in FIG. 1, according to another embodiment of the present invention.

FIG. 11 is an example XML source code of the initial startup markup document INDEX.XML read from a disc, according to an embodiment of the present invention.

FIG. 12 is an example interface structure for a script language for dealing with text data linked to an element of a link tag in an initial startup markup document, according to an embodiment of the present invention.

FIG. 13 is an example XML source code downloaded from the Internet, according to an embodiment of the present invention.

FIG. 14 is an example source code of a program to retrieve a reproducing control file, according to an embodiment of the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

In this specification, a “markup document” typically indicates a document formatted according to a standard of organizing and tagging elements, such as a document written in a markup language, an extensible markup language (XML) or a standard generalized markup language (SGML); a source code which is written in a script language (e.g., Java script) or an execution code (e.g., Java applet); or a document which is linked to an execution code or in which an execution code is embedded. Furthermore, the “markup document” can mean any file embedded in a markup document and used for image display. In other words, a markup document is a kind of application reproducing audio/video (AV) data in an interactive mode. An “interactive screen” is a screen that is displayed during reproduction in an interactive mode. In the interactive screen, an AV screen is typically embedded in a markup document screen. An “AV screen” indicates a screen on which AV data is reproduced and displayed so that a user can visually perceive the AV data. A “markup document screen” indicates a screen on which a markup document is reproduced and displayed so that a user can visually perceive the markup document.

A reproducing apparatus of the present invention can reproduce contents of a disc in an interactive mode regardless of whether the disc supports the interactive mode. Furthermore, the reproducing apparatus of the present invention can update interactive reproduction contents displayed on a markup document screen together with the contents recorded on the disc.

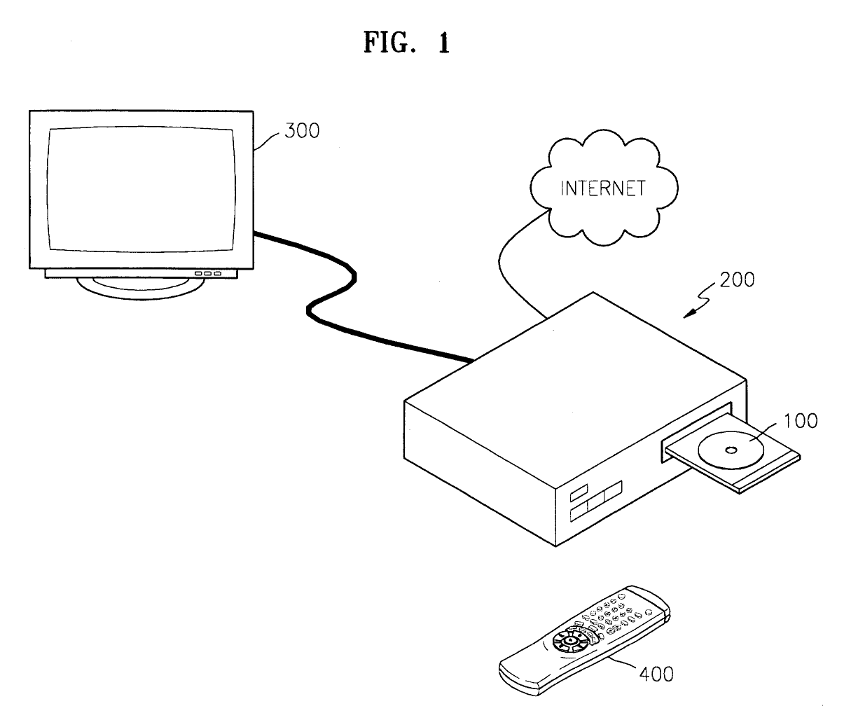

FIG. 1 is a schematic diagram of a reproducing system according to an embodiment of the present invention. Referring to FIG. 1, the reproducing system comprises a disc 100 having contents recorded thereon, such as movies and interactive reproduction information corresponding to the movies, a reproducing apparatus 200, a television (TV) 300 ( i.e., a display unit according to an embodiment of the present invention), and a remote controller 400. The remote controller 400 transmits a control command input by a user to the reproducing apparatus 200. When information necessary for reproducing in an interactive mode (i.e., interactive reproduction information) is not recorded on the disc 100, in response to the user's control command, the reproducing apparatus 200 accesses the Internet, downloads the necessary information, reproduces relevant contents in the interactive mode, and transmits the reproduced relevant contents to the TV 300. In addition, according to a user's control command, the reproducing apparatus 200 can access the Internet and download a new version of the contents recorded on the disc 100, and in particular, updated interactive reproduction information as well as to the AV data. The TV 300 displays the contents, including the interactive reproduction information, received from the reproducing apparatus 200 via the Internet and/or from the disc 100.

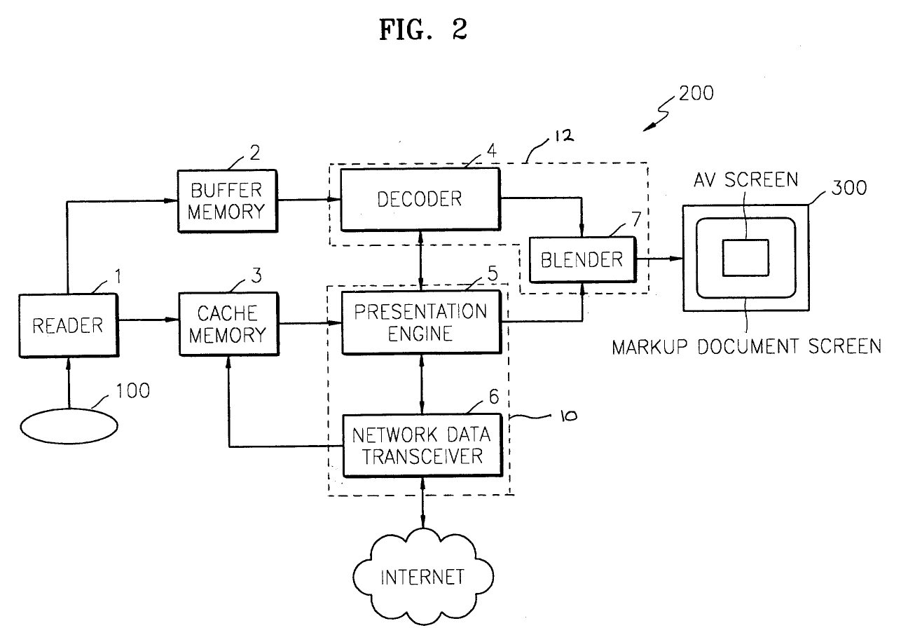

FIG. 2 is a block diagram of the reproducing apparatus 200 shown in FIG. 1, according to an embodiment of the present invention. Referring to FIG. 2, the reproducing apparatus 200 comprises a reader 1, a buffer memory 2, a cache memory 3, a decoder 4, a presentation engine 5, a network data transceiver 6, and a blender 7.

The reader 1 reads data from the disc 100, i.e., a digital versatile disc (DVD), according to the present invention. The buffer memory 2 buffers the AV data read by the reader 1. The cache memory 3 caches a markup document which is either read by the reader 1 or downloaded from the Internet by the network data transceiver 6. The presentation engine 5 interprets a markup document, which is read from the cache memory 3, to check a position of a display window displaying an AV data stream output from the decoder 4, on the display unit 300. The network data transceiver 6 downloads information necessary for reproducing in the interactive mode, which is typically at least one of a reproducing control file and a markup document from the Internet when a disc does not support the interactive mode, or when updating contents displayed on an interactive screen in case of a conventional interactive disc or a disc 100. The blender 7 blends (combines) decoded AV data from the decoder 4 and interactive reproduction information from the at least one of the reproducing control file and the markup document, according to known techniques, and outputs a result of blending to the TV 300.

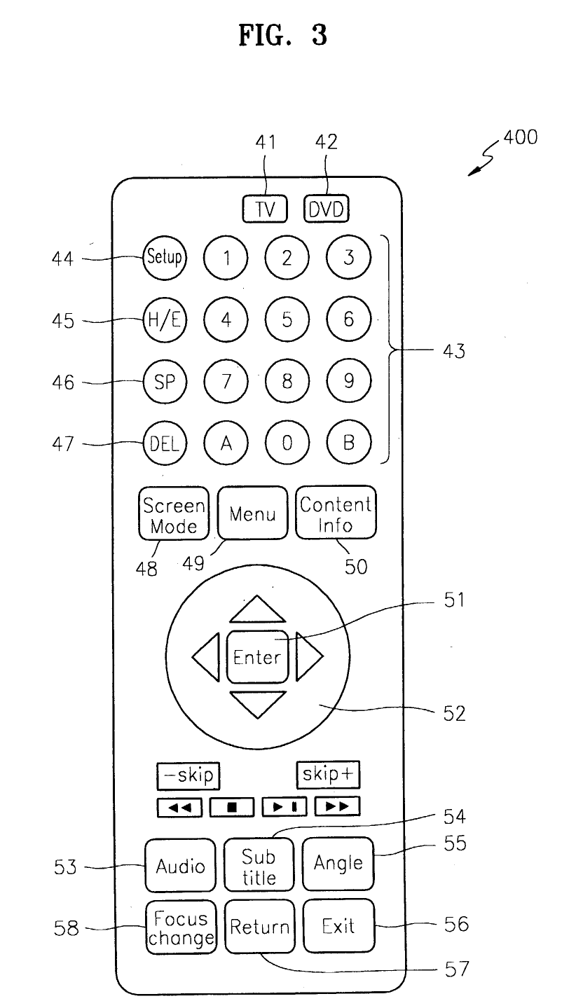

FIG. 3 is a schematic diagram of the remote controller 400 shown in FIG. 1, according to an embodiment of the present invention. Referring to FIG. 3, the remote controller 400 comprises a variety of functional buttons, some examples of which are described herein. A TV button 41 is used for receiving externally broadcast signals to watch external broadcast programs through the TV 300. A DVD button 42 is used to view AV data, which is provided from the reproducing apparatus 200, through the TV 300. A numeral/character button group 43 for selecting a channel number is disposed in the upper front portion of the remote controller 400. A Setup 44 denotes a button for calling an On Screen Display (OSD) menu to set up the reproducing apparatus 200. An H/E 45 denotes a language conversion button. An SP 46 denotes a space button, and a DEL 47 denotes a delete button. A Screen Mode 48 denotes a button for converting a display mode on a screen, a Menu 49 denotes a button for calling a menu screen, and a Content Info 50 denotes a button for downloading predetermined information from the Internet.

Reference numeral 52 denotes a group of direction keys for moving (placing) a highlight on information displayed on the display screen of the TV 300. An Enter 51 denotes a button for selecting a highlighted menu item. When a video title is reproduced, a user can convert the language of audio using an Audio 53, convert the language of a caption using a Sub title 54, and convert the angle of a screen using an Angle 55. A Focus change 58 button is used for moving a current highlighted information on the display screen. A Return 57 button is used for movement between levels in a menu having a hierarchical structure. An Exit 56 is a button for moving from the menu screen to a video title reproducing screen. The remote controller 400 shown in FIG. 3 is an example provided for the DVD disc 100 on which a video title is recorded and the present invention is not limited to such a remote control configuration. Accordingly, specific functional buttons and the number of the buttons may be changed. In addition, some of the functional buttons may be placed into the OSD menu. On the contrary, some of the OSD menu functions may be manifested as functional buttons.

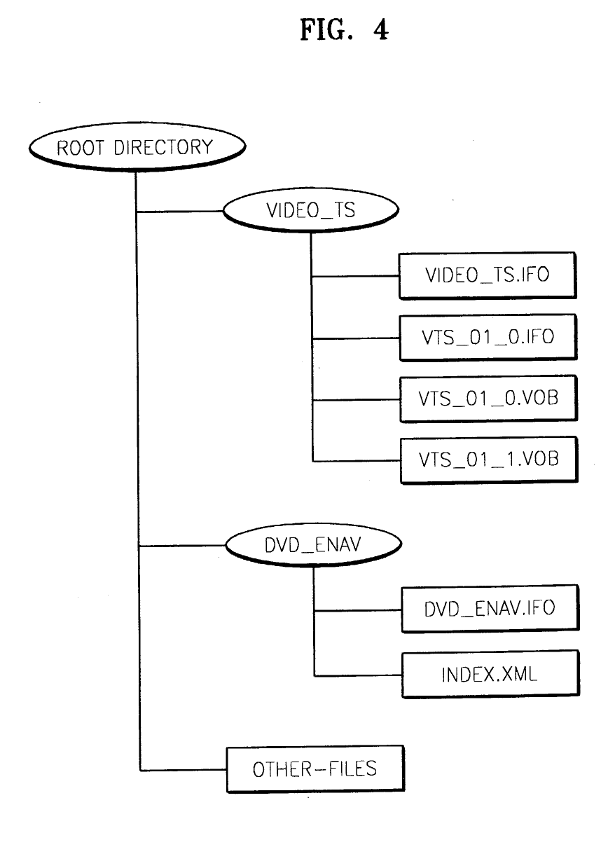

FIG. 4 is a diagram of a directory structure of a disc 100 which supports an interactive mode, according to an embodiment of the present invention. Referring to FIG. 4, a root directory includes a video directory VIDEO_TS containing AV data. In the video directory VIDEO_TS, a file VIDEO_TS.IFO contains information for controlling reproduction of all video titles on the disc. For example, language information that is set to a default value for the video title is recorded in the file VIDEO_TS.IFO. Behind the file VIDEO_TS.IFO is recorded a file VTS_{—}01_{—}0.IFO, which contains information for controlling reproduction of a first video title set, and files VTS_{—}01_{—}0.VOB and VTS_{—}01_{—}1.VOB, which constitute the first video title set. The files VTS_{—}10_{—}0.VOB and VTS_{—}01_{—}1.VOB are video titles, i.e., video objects which constitute the first video title set. Each file VTS_{—}01_{—}0.VOB and VTS_{—}01_{—}1.VOB comprises a video object unit (VOBU) which comprises a navigation pack, a video pack, and an audio pack. The more detailed configuration of the VOBU is disclosed in a DVD-Video specification “DVD-Video for Read Only Memory Disc 1.0.”

The root directory also includes an interactive directory DVD_ENAV which stores information for supporting an interactive mode. A reproducing control file DVD_ENAV.IFO is recorded in the interactive directory DVD_ENAV. For example, typically the DVD_ENAV.IFO reproducing control file records definitions and configurations of a relevant directory of the disc 100, number of titles included in each directory, basic information about each title, information about language used in each title, reproducing control information which can replace the VIDEO_TS.IFO and VTS_{—}01_{—}0.IFO files for each title, information about caption and font used in each title, information on markup documents used to control interactive reproduction, including display information, such as resolution and color, copyright information, and text data produced and inserted by a content provider. For the copyright information, an International Standard Recording Code (ISRC) may be recorded. The ISRC is an international standard code used to identify music, songs, and music video and is granted by the Recording Industry Association of America (RIAA). The ISRC may be used as a video title identifier.

The text data in the reproducing control file (DVD_ENAV.IFO) may have a predetermined text data configuration and may be provided with a predetermined application program interface API to search the text data. For example, a text data configuration proposed in the Korean Patent Application No. 2001-0065392 may be used. Furthermore, in the interactive directory DVD_ENAV may be stored an initial startup markup document INDEX.XML (i.e., a reproducing markup document) which is displayed together with a video title or other markup documents. In addition, other files to be inserted into and displayed together with a markup document may be stored in the interactive directory DVD_ENAV.

A burst cutting area (BCA) code may be recorded on back of the disc 100. The BCA code is recorded on the disc 100 along the inner circumference, typically as a bar code to protect a copyright. The BCA code may also be used as a disc identifier. A code (e.g., universal product code (UPC)) may also be recorded as a disc identifier or a video title identifier in a different position than the BCA code and the ISRC code.

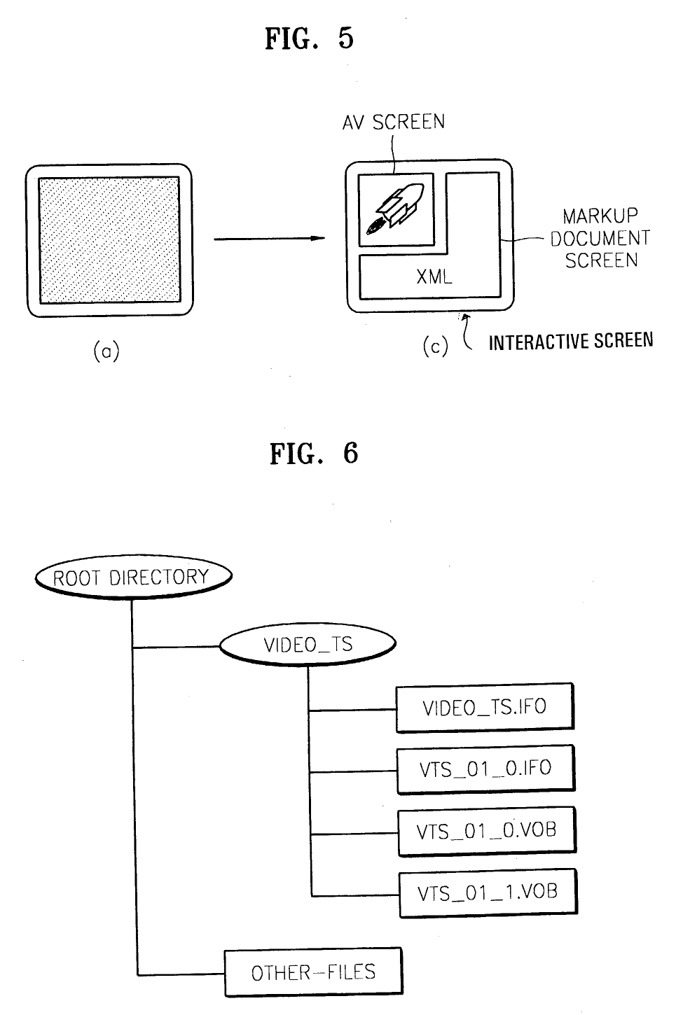

FIG. 5 is a display screen diagram of reproducing contents from a disc which supports an interactive mode, according to an embodiment of the present invention. Referring to FIG. 5, when a user inserts an interactive disc 100 into a reproducing apparatus 200, the reproducing control file DVD_ENAV.IFO is read from the disc, the reproducing control file DVD_ENAV.IFO is analyzed, and the initial startup markup document INDEX.XML is read by the reproducing apparatus 200. If the initial startup markup document INDEX.XML is linked to the reproducing control file DVD_ENAV.IFO, the reproducing apparatus reproduces a relevant video title in an interactive mode based on the link. Thus, in a state (a) shown in FIG. 5, in which nothing is displayed, an AV screen displaying a video title and a markup document screen displaying a markup document are simultaneously displayed in the interactive mode (i.e., the interactive screen), as shown in a state (c) in FIG. 5.

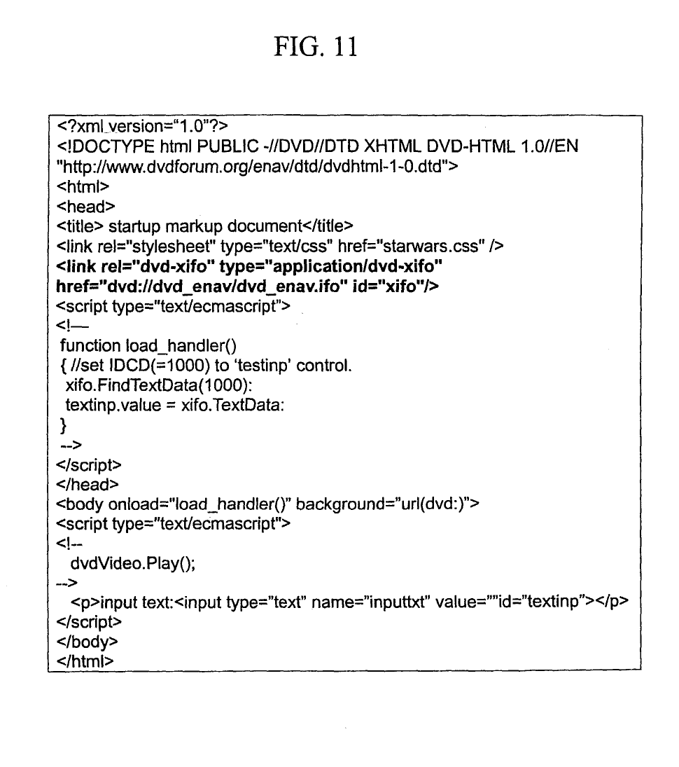

FIG. 11 is an example of XML source code of the initial startup markup document INDEX.XML read from the disc 100, according to an embodiment of the present invention. In FIG. 11, source code <link rel=“did-xifo” type=“application/dvd-xifo” href=“dvd://dvd_enav/dvd_enav.ifo” id=“xifo”/> is an instruction to reproduce a relevant video title based on the file DVD_ENAV.IFO recorded on the disc 100. Advantageously, the initial startup markup document accommodates logic to link two or more reproducing files or logic to dynamically and/or automatically update contents of the interactive screen. In addition, this link tag provides a method of retrieving text data from the file DVD_ENAV.IFO. For example, in FIG. 11, source code “xifo.FindTextData(1000):” is an instruction to find a text item for which an identifier code (IDCD) in the file DVD_ENAV.IFO is 1000, and to store the text item in xifo.TextData. Data stored in the xifo.TextData may be read in the manner of x=xifo.TextData. By using this method of reading text data, a plurality of reproducing control files can be linked to a markup document. In particular, various reproducing control files can be used for different purposes, such as controlling reproduction, providing various types of text data, etc.

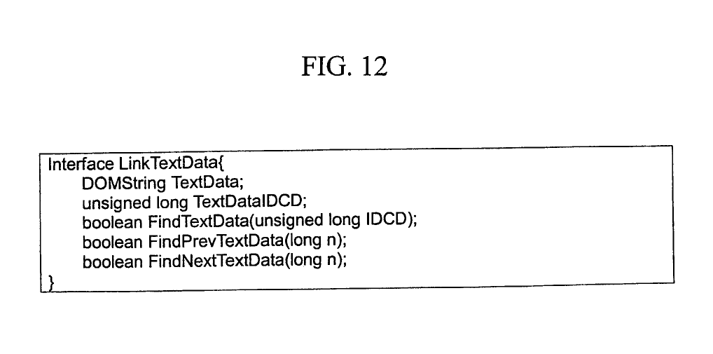

FIG. 12 is an example of an interface structure for a script language for dealing with text data linked to an element of a link tag in an initial startup markup document, according to an embodiment of the present invention. Accordingly, in FIG. 12, if an identifier code using a link tag in the XML document matches a desired text data identifier code in the DVD_ENAV.IFO file, a start address of a relevant text data is found and the text data is retrieved. Further, text data recorded at an n-th place before or after a position of previously found text data can be retrieved.

FIG. 6 is a diagram of a directory structure of a DVD disc which does not support an interactive mode. Referring to FIG. 6, a root directory includes a video directory VIDEO_TS containing AV data. The video directory VIDEO_TS is provided with a file VIDEO_TS.IFO which contains information for controlling reproduction of each video title recorded on the DVD disc. An identifier of a disc or a video title is recorded in the file VIDEO_TS.IFO. The remaining data configuration of the VIDEO_TS directly is the same as that shown in FIG. 4, and thus a description thereof will be omitted.

The root directory shown in FIG. 6 does not include an interactive directory which stores information for supporting an interactive mode. In other words, the reproducing control file DVD_ENAV.IFO and the initial startup markup document INDEX.XML of the invention are not stored in a non-interactive DVD disc.

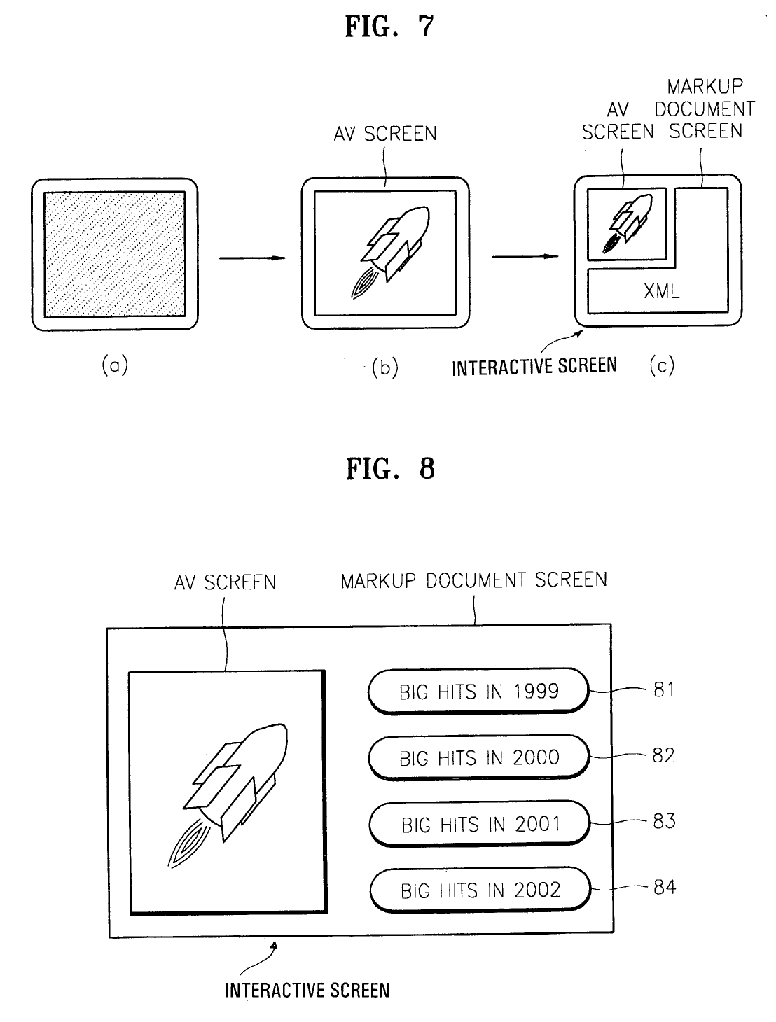

FIG. 7 is a display screen diagram of reproducing contents in an interactive mode from a DVD disc that does not support the interactive mode, according to an embodiment of the present invention. Referring to FIG. 7, when a user inserts a non-interactive DVD disc into a reproducing apparatus 200, a video title recorded on the non-interactive disc is reproduced in a video mode. In particular, an empty screen, on which nothing is displayed, as shown in a state (a) in FIG. 7, is converted into an AV screen, on which the video title is reproduced, as shown in a state (b) in FIG. 7. If the user, for example, presses the Content Info 50 button on the remote controller 400, the reproducing apparatus 200 determines via a connected external apparatus or a network, such as Internet, if at least one of a reproducing control file DVD_ENAV.IFO and a markup document INDEX.XML exist for the video title so that reproduction can be performed in an interactive mode by downloading the at least one of the reproducing control file and the markup document. The reproducing control file and the markup document for the interactive mode may be downloaded in various orders. Consequently, an AV screen and a markup document screen are simultaneously displayed in the interactive mode (i.e., the interactive screen), as shown in a state (c) in FIG. 7.

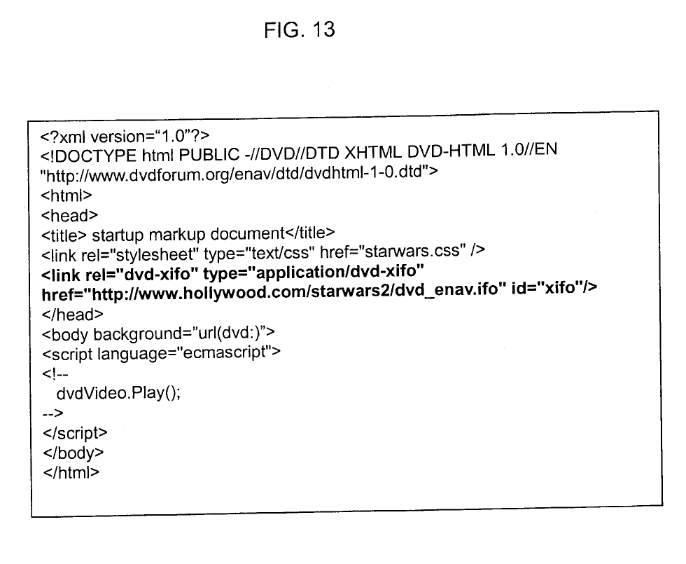

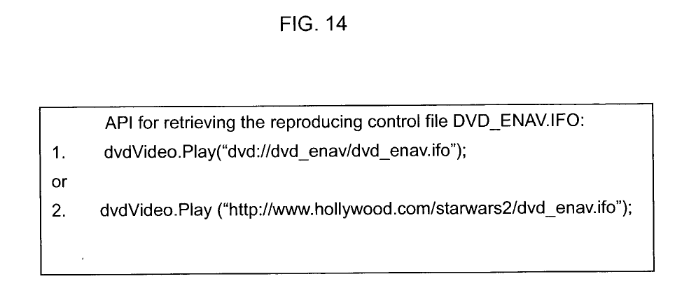

The reproducing control file and the initial startup markup document can be downloaded from a source external to the reproducing apparatus 200 as follows. For example, the initial startup markup document, which can include information on downloading of the reproducing control file, can be downloaded from the Internet upon a request from the reproducing apparatus 200. FIG. 13 is an example of the file INDEX.XML that is downloaded from the Internet, according to an embodiment of the present invention. In FIG. 13, source code <link rel=“dvd-xifo” type=“application/dvd-xifo” href=“http://www.hollywood.com/starwars2/dvd_enav.ifo” id=“xifo”/> is an instruction to read the file DVD_ENAV.IFO, which is stored on the Internet in a designated universal resource locator (URL), i.e., http://www.hollywood.com/starwars2/dvd_enav.ifo. The video title can be reproduced interactively based on the read reproducing control file DVD_ENAV.IFO. Alternatively, as shown in FIG. 14, instead of a link tag in the initial startup markup document, the markup document can contain execution code with application programming interface (API) calls to retrieve the reproducing control file from the Internet. Further, a reproducing-control-markup document link tag can be embedded in the reproducing control file DVD_ENAV.IFO to provide instructions for downloading a markup document, such as the initial startup markup document, controlling interactive reproduction.

Further, a reproducing control file link tag can be embedded in the reproducing control file DVD_ENAV.IFO to provide instructions for downloading the reproducing control file. Therefore, a disc producer (e.g., a manufacturer, a content provider, such as TRISTAR) can insert the source code instruction <link rel=“dvd-xifo” type=“application/dvd-xifo” href=“http://www.tristar.com/forest2003.ifo”/> into the file DVD_ENAV.IFO or a markup document within the interactive directory DVD_ENAV on a disc 100 during an authoring process to provide downloading instructions for a reproducing control file from a particular URL corresponding to the content provider. This method can be used to reproduce in the interactive mode by providing a reproducing control file through a server in communication with the reproducing apparatus 200 every time. For example, a markup document, which contains information for linking a new reproducing control file, can be recorded on a disc 100 during production of the disc in advance in anticipation of a new or future reproducing control configuration produced after production of the disc, so that when a video title and the markup document are simultaneously reproduced in an interactive mode, a new markup document screen having an AV screen can be displayed, in which the video title is displayed based on the new reproduction control file obtained through the link information recorded on the disc.

FIG. 8 is a display screen diagram of updating a content in an interactive mode reproducing screen. Referring to FIG. 8, anchors (menu items) 81, 82, 83, and 84 are displayed on a markup document screen, which is displayed together with an AV screen (i.e., an interactive screen). For example, it is assumed that a disc is produced in March of 2001. If a user, via the remote controller 400 (e.g., using menu, direction and enter buttons 49, 52 and 51), selects the anchor 81 indicating big hits in 1999 or the anchor 82 indicating big hits in 2000, relevant content can be reproduced based on the reproducing control file DVD_ENAV.IFO that is recorded on the disc.

In FIG. 8, however, reproducing control files, which are to be linked to the anchor 83 indicating big hits after March of 2001 and the anchor 84 indicating big hits in 2002, cannot be created when the disc is produced because such future reproducing control configurations are not available at the time the disc is produced in March of 2001. In this case, a disc producer can make the anchors 83 and 84 in advance and put (store) new reproducing control files into a server apparatus at a relevant URL when the same is available, so that, for example, content on a markup document screen or an AV screen (a relevant video title) embedded in the markup document screen can be dynamically and/or automatically updated, according to the described interactive reproducing methods of the invention, based upon the new reproducing control files.

In addition, information indicating whether a reproducing control file has been made to control reproduction may be embedded into the reproducing control file and/or a markup document, to allow a reproducing apparatus 200 to automatically determine whether the downloaded file is to be used for controlling reproduction or as text data information. In other words, when a user selects the anchor 83 or 84, just AV data can be read but an interactive screen is not displayed until a new reproducing control file can be or has been located, for example, via a link to a URL. After a new reproducing control information is put on a server apparatus of the URL, content complying with/according to the new reproducing control configuration can be displayed in an interactive screen.

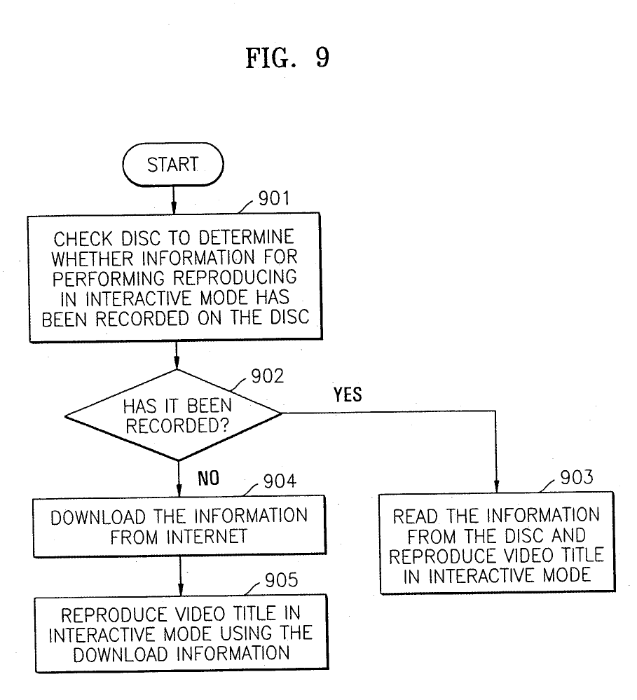

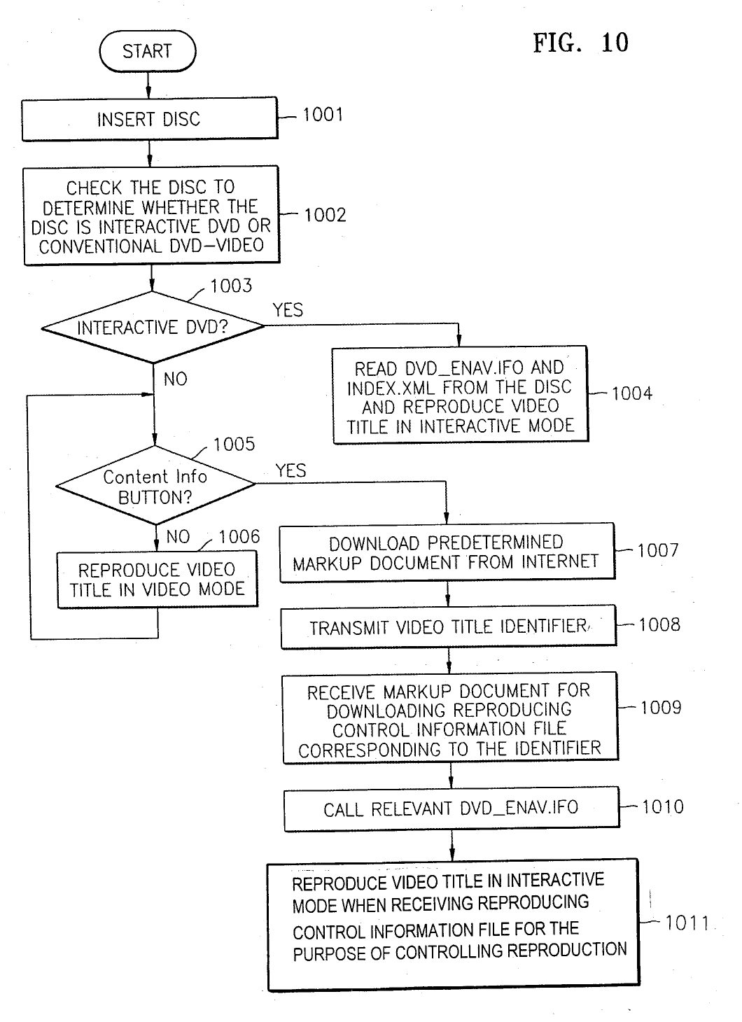

FIG. 9 is a flowchart of a reproducing method using the reproducing system shown in FIG. 1, according to an embodiment of the present invention. Referring to FIG. 9, if a user inserts the disc 100 of FIG. 2 into a disc deck provided in the reproducing apparatus 200, at operation 901, the presentation engine 5 determines whether information, which is necessary for reproducing in an interactive mode, that is, a reproducing control file and a markup document have been recorded on the disc 100. If, at operation 902, it is determined that the reproducing control file and the markup document have been recorded on the disc 100, at operation 903 they are read to reproduce a relevant video title in an interactive mode. If, at operation 902, it is determined that the reproducing control file and the markup document have not been recorded on the disc 100, at operation 904, the network data transceiver 6 downloads a reproducing control file and a markup document from the Internet and stores them in the cache memory 3. Typically, a disc identifier or video title identifier, which is recorded on the disc 100 to identify a disc or video title, is used as a key value for downloading the reproducing control file and the markup document for a particular video title. At operation 905, the presentation engine 5 reproduces the video title in an interactive mode, using the reproducing control file and the markup document stored in the cache memory 3.

FIG. 10 is a flowchart of a reproducing method using the reproducing system shown in FIG. 1, according to another embodiment of the present invention. Referring to FIG. 10, at operation 1001, a user inserts a disc, which can be an interactive DVD 100, a conventional interactive DVD or a non-interactive DVD-video, into the reproducing apparatus 200. At operation 1002, the reproducing apparatus 200 checks the disc to determine whether the disc is an interactive type DVD or a non-interactive DVD-video. If, at operation 1003, it is determined that the disc is an interactive type DVD, at operation 1004, information for reproducing in an interactive mode, which in case of the DVD 100 is typically comprises of a reproducing control file DVD_ENAV.IFO and an initial startup markup document INDEX.XML, can be read from the disc so as to reproduce a relevant video title in an interactive mode. In particular, at operation 1004, processes of the reproducing apparatus 200, as embodied in a presentation manager 10 and a reproducer 12, comprise interactively reproducing as well as updating contents of an interactive screen for any type of interactive type DVD, such as the DVD 100 or other conventional interactive DVDs, according to the invention. If, at operation 1003, it is determined that the disc is a non-interactive DVD-video, and if, at operation 1005, the interactive mode is not selected, at operation 1006, the video title is reproduced in a video mode.

If, at operation 1003, it is determined that the disc is a non-interactive DVD-video, and if, at operation 1005, the interactive mode is selected, for example, if the user presses the Content Info button 50 provided on the remote controller 400, at operation 1007, the reproducing apparatus 200 accesses a predetermined interactive server apparatus through the Internet, using the network data transceiver 6, and downloads a predetermined markup document from the Internet. At operation 1007, the downloaded markup document contains a client execution code recognizing a disc identifier of the non-interactive DVD inserted into the reproducing apparatus 200 or a video title identifier (e.g., ISRC) of a video title desired to be reproduced. Typically, the client execution code is a source code in a script language. However, the client execution code may be composed in another program language, which can be executed in the presentation engine 5. Typically, the disc identifier or the video title identifier is recorded in a file VIDEO_TS.IFO.

At operation 1007, the client execution code is executed in the presentation engine 5 so that the disc identifier or the video title identifier is read, and, at operation 1008, the network data transceiver 6 transmits the identifier to the interactive server apparatus. At operation 1009, the interactive server apparatus transmits a markup document, which has a similar function to a markup document INDEX.XML for downloading a new reproducing control file corresponding to the identifier, to the network data transceiver 6. The markup document is linked to the reproducing control file through a link tag or contains an execution code using API for downloading the reproducing control file. At operation 1010, the reproducing control file DVD_ENAV.IFO is downloaded. The reproducing control file typically contains information indicating that the reproducing control file is made for controlling reproduction. In the meantime, the reproducing control file may contain URL information indicating a location of a new markup document that is necessary for reproducing the video title in the interactive mode. That is, the reproducing control file may designate the location of the initial startup markup document INDEX.XML. At operation 1011, the presentation engine 5 analyzes the downloaded reproducing control file DVD_ENAV.IFO, receives the new markup document necessary for reproducing in the interactive mode, and reproduces the video title and the markup document in the interactive mode.

In FIG. 10, operations 1007 and 1008 may be combined as follows. For example, the network data transceiver 6 can transmit the disc identifier or the video title identifier to a predetermined interactive server apparatus, and the interactive server apparatus can transmit the markup document for downloading the reproducing control file to the reproducing apparatus 200 in response to the identifier.

In the above embodiments, content recorded on a disc is a video title. However, the present invention can also be applied to other various types of contents, such as audio titles and electronic books.

As described above, according to the present invention, even if information for reproducing content in an interactive mode is not recorded on a disc, the content can be reproduced in the interactive mode (i.e., interactive playback). In addition, by modifying and updating a reproducing control file and a markup document which are stored in a server apparatus, a content provider can provide the latest information and allow a content to be reproduced in a new format. Furthermore, since link information concerning a new reproducing control file to be provided in the future can be recorded on a disc 100 in advance, content recorded on the disc 100 can be reproduced based on the new reproducing control file, so that content of an interactive screen can be updated. In particular, content on a markup document screen can be dynamically (in real-time) and/or automatically updated. Processes of the invention as the presentation engine 5 and the network data transceiver 6 (presentation manager 10), providing a dynamically and/or automatically updated interactive content reproducer, can be embodied in software and/or hardware and executed using known techniques. Further, the reproducing apparatus 200 executes software (e.g., browsers) reading and analyzing/processing tagged element documents to provide and to update the interactive screen contents.

Although a few preferred embodiments of the present invention have been shown and described, it would be appreciated by those skilled in the art that changes may be made in the embodiments without departing from the principles and spirit of the invention, the scope of which is defined in the claims and their equivalents.

What is claimed is:

1. A method of reproducing a content interactively from an information storage medium, comprising:
receiving interactive reproduction information from Internet or reading the information from the storage medium; and
reproducing the content interactively based on the received or read information.

2. The method of claim 1, wherein the receiving of the interactive reproduction information comprises:
determining whether the interactive reproduction information is recorded on the information storage medium; and
requesting the interactive reproduction information from a predetermined server apparatus on the Internet if the interactive reproduction information has not been recorded on the information storage medium.

3. The method of claim 2, wherein the requesting of the interactive reproduction information comprises:
transmitting an identifier of the content to the server apparatus; and
receiving at least one of a reproducing control file and a markup document corresponding to the identifier, from the server apparatus.

4. The method of claim 2, further comprising storing a markup document containing instructions to download a reproducing control file, as the interactive reproduction information, from the server apparatus, on the information storage medium and the reproducing control file is requested and received so that an interactive screen is updated whenever the reproducing control file in the server apparatus is updated.

5. The method of claim 1, further comprising recording a markup document containing linking information to a reproducing control file, as the interactive reproduction information, on the information storage medium in advance during production of the information storage medium and the reproducing control file is received from the Internet so that a new interactive screen displayable when a recorded video title, as the content, is reproduced together with the markup document interactively.

6. A method of reproducing a video title from a disc in an interactive mode, the method comprising:
receiving information, which is necessary for reproducing the video title in the interactive mode, from Internet; and
reproducing the video title in the interactive mode based on the received information.

7. The method of claim 6, wherein a reproducing control file and a reproducing markup document necessary for reproducing the video title in the interactive mode are received.

8. The method of claim 7, wherein the receiving of the reproduction control file and the reproducing markup document comprises:
transmitting an identifier of the video title to a server apparatus on the Internet; and
receiving at least one of the reproducing markup document and the reproducing control file which correspond to the identifier.

9. The method of claim 8, further comprising receiving a markup document, which contains a client execution code recognizing the identifier of the video title, from the server apparatus.

10. The method of claim 9, wherein the receiving of the reproducing markup document and the reproducing control file comprises:
receiving the reproducing markup document for downloading the reproducing control file; and
receiving the reproducing control file that is linked to the received reproducing markup document.

11. The method of claim 10, wherein the received reproducing markup document contains either a link tag linked to the reproducing control file or an execution code with application program interface (API) calls retrieving the reproducing control file.

12. The method of claim 11, wherein a text-data link tag in the reproducing markup document is used to retrieve text data from the reproducing control file.

13. The method of claim 12, wherein if an identifier of the text-data link tag matches an identifier of the text data in the reproducing control file, the text data of the matched identifier is retrieved or the text data recorded at an n-th place before or after a position of previously found text data is retrieved.

14. The method of claim 11, wherein the reproducing control file contains designation information designating that the reproducing control file is made for the purpose of controlling reproduction.

15. The method of claim 14, further comprising determining whether the received reproducing control file is to be used for controlling reproduction or used as text data information, based on the designation information.

16. The method of claim 15, wherein the received reproducing control file is used for reading text data until it is determined that the reproducing control file is made for the purpose of controlling reproduction, based on the designation information.

17. An apparatus reproducing content from an information storage medium in an interactive mode, the apparatus comprising:
a reader reading the content from the information storage medium;
a decoder decoding the read content; and
a network data transceiver receiving interactive reproduction information from Internet,
wherein the apparatus reproduces the content in the interactive mode using the interactive reproduction information read from the information storage medium or received through the network data transceiver.

18. The apparatus of claim 17, wherein the interactive reproduction information comprises a reproducing control file for reproducing the content and a markup document displayed together with the content, and the apparatus further comprises:
a presentation engine analyzing the reproducing control file and the markup document to execute and/or reproduce them; and
a blender blending the decoded content and a reproduced markup document.

19. The apparatus of claim 17, wherein the network data transceiver transmits an identifier of the content to a server apparatus on the Internet and receives interactive reproduction information corresponding to the identifier from the server apparatus.

20. The apparatus of claim 19, wherein the information storage medium stores a markup document containing instructions to download a reproducing control file, as the interactive reproduction information, from the server apparatus, so that an interactive screen is updated whenever the reproducing control file is updated in the server apparatus.

21. The apparatus of claim 20, wherein the markup document is recorded in the information storage medium during production of the information storage medium in advance anticipating a new reproducing control file to be produced after the production of the information storage medium, so that a new interactive screen is displayable when a video title recorded in the information storage medium is reproduced together with the markup document in the interactive mode.

22. An apparatus reproducing a video title from a disc in an interactive mode, the apparatus, comprising:
a presentation manager requesting and receiving interactive reproduction information from Internet; and
a reproducer reproducing the video title in the interactive mode based upon the received interactive reproduction information.

23. The apparatus of claim 22, wherein the interactive reproduction information comprises a reproducing control file and a markup document.

24. The apparatus of claim 22, wherein the presentation manager transmits an identifier of the video title to a server on the Internet and receives a reproducing control file and a reproducing markup document corresponding to the identifier, as the interactive reproduction information.

25. The apparatus of claim 24, wherein the presentation manager requests and receives an identifier markup document containing a client execution code recognizing the identifier of the video title, from the server apparatus.

26. The apparatus of claim 22, wherein the presentation manager requests and receives a markup document for downloading a reproducing control file linked to the received markup document, and receives an initial startup markup document set in the received reproducing control file.

27. The apparatus of claim 26, wherein the received markup document contains either a link tag linked to the reproducing control file or an execution code with application program interface (API) calls retrieving the reproducing control file.

28. The apparatus of claim 27, wherein a text-data link tag in the reproducing document is used to retrieve text data from the reproducing control file.

29. The apparatus of claim 28, wherein if an identifier of the text-data link tag matches an identifier of the text data in the reproducing control file, the text data of the matched identifier is retrieved or the text data recorded at an n-th place before or after a position of previously found text data is retrieved.

30. The apparatus of claim 27, wherein the reproducing control file contains designation information designating that the reproducing control file is made for the purpose of controlling reproduction.

31. The apparatus of claim 30, wherein the presentation manager determines whether the received reproducing control file is to be used for controlling reproduction or used as text data information, based on the designation information.

32. The apparatus of claim 31, wherein the received reproducing control file is used for reading text data until it is determined that the reproducing control file is made for the purpose of controlling reproduction, based on the designation information.

33. A computer readable storage storing multimedia content and storing a process of controlling a data reproducing apparatus to dynamically update an interactive screen of the multimedia content.

34. An apparatus interactively reproducing a multimedia title from a non-interactive disc, comprising a programmed computer processor determining whether a disc is an interactive disc, retrieving interactive reproduction information from Internet via markup document links if the disc is non-interactive, and reproducing the multimedia title interactively on an interactive screen based upon the retrieved interactive reproduction information.

35. The apparatus of claim 34, wherein the programmed processor further dynamically updates the interactive screen.
